(19) United States
(12) Patent Application Publication
(10) Pub. No.: US 2012/0036496 A1
(43) Pub. Date: Feb. 9, 2012

(54) PLUG-IN BASED HIGH AVAILABILITY APPLICATION MANAGEMENT FRAMEWORK (AMF)

(75) Inventors: Bruce Yang, Beijing (CN); Guodong Li, Beijing (CN); Victor Liu, Beijing (CN); Zhenghua Xu, Beijing (CN)

(73) Assignee: COMPUTER ASSOCIATES THINK, INC., Islandia, NY (US)

(21) Appl. No.: 12/851,167

(22) Filed: Aug. 5, 2010

(51) Int. Cl. G06F 9/445; G06F 9/44

(52) U.S. Cl. 717/121; 717/174

(57) ABSTRACT

A high availability method enabling addition and removal of an application plug-in comprises launching the high availability system using a processor, said high availability system having an application framework (AMF), requesting data obtainable by the application plug-in from the application framework, and when the application plug-in does not exist in the application framework, registering the application plug-in in the application framework. AMF can comprise a list of additional application plug-ins. The list can comprises a unique id, a name, and a path to dynamic load libraries for each application plug-in. AMF can add the application plug-in by adding the application plug-in dynamic load library files to the installation folder and adding application plug-in information to the configuration file. AMF can remove the application plug-in by deleting the application plug-in dynamic load library files from the installation folder and deleting the application plug-in information from the configuration file.

### FIELD OF THE INVENTION

The present disclosure relates generally to computer systems and software, and more particularly to a process for application management.

### BACKGROUND OF THE INVENTION

The disruption, even for a few days, of a business' technology and automated systems could cause severe business distress, such as financial losses, and could even threaten the survival of the business. Hence businesses develop disaster recovery plans to deal with potential disasters, to minimize disruptions of critical functions, and to provide the capability to recover operations expediently and successfully should a disaster occur.

One issue with disaster recovery is data protection. Continuous Data Protection (CDP) products track changes to application data to enable data administrators to quickly recover to the point in time immediately before the application was compromised, which is functionality that organizations require to minimize data loss and meet aggressive recovery objectives. CDP products can provide the ability to simplify automatic testing of the failover process to validate disaster recovery plans, including a rollback of test transactions applied to the replica. Products exist to help ensure “24×7” protection and availability of key business applications and data, to provide application-aware replication and automatic failover for various software systems.

Business disruption can be avoided by not only protecting data but also enabling applications and application servers to continue or quickly resume processing with minimal downtime. Such disruption avoidance can be obtained through high availability (HA) software systems for one or more applications. HA systems typically provide availability of data and programs through the use of additional hardware and software that executes the pre-defined HA application (s) off-site and/or at a location other than the location of the application that is not currently available because a disaster occurred. To make an application available at all times, HA systems run the application with its data; accordingly, HA systems have multiple modules for performing various functions such as application data discovery, configuration, network and/or application environment(s) validation, managing services, including start/stop/input/output, etc., for the HA application, checking the status of the active server, switching between the standby server and the original server, etc. However, it is very difficult to support a new feature or application based on the current HA system, because it needs to implement the above functions for the new feature/application. That is, code must be added in each module of the HA system, which requires the developer to become familiar with all the logics in each module of the HA system. Further it is difficult to perform unit testing for the newly added application, and to maintain the HA system when more and more applications are involved.

### SUMMARY OF THE INVENTION

The inventive system and method overcomes the difficulties in adding application support to the HA system by using Application Management Framework (AMF) along with involving plug-in. A high availability system enabling addition, modification and removal of an application plug-in comprises a central processor executing a manager, an application framework, an active host having a host engine executing on a host processor on the active host, and a standby host corresponding to the active host, the standby host having a standby engine and a standby processor on the standby host, wherein the manager sends a request to the active host for data obtainable by the application plug-in, the host engine sends the request to the application framework, and when the application plug-in does not exist in the application framework, the application framework adds the application plug-in and obtains the data using the application plug-in. In one embodiment, the application framework comprises at least a list of additional application plug-ins available on the active host. In one embodiment, the list comprises a unique id, a name, and a path to dynamic load libraries for each application plug-in. In one embodiment, the manager includes at least a configuration file and an installation folder having application plug-in dynamic load library files. In one embodiment, the application framework adds the application plug-in to the application framework by adding the application plug-in dynamic load library files to the installation folder and adding application plug-in information to the configuration file. In one embodiment, the application framework removes the application plug-in from the application framework by deleting the application plug-in dynamic load library files from the installation folder and deleting the application plug-in information from the configuration file. In one embodiment, the application framework removes the application plug-in from the application framework in response to a user request.

The inventive method comprises launching the high availability system using a processor, the high availability system having an application framework, requesting data obtainable by the application plug-in from the application framework, and when the application plug-in does not exist in the application framework, registering the application plug-in in the application framework. In one embodiment, the step of registering the application plug-in comprises steps of loading the application framework, reading plug-in configuration, and loading plug-in information according to the configuration. In one embodiment, the step of registering further comprises adding the application plug-in dynamic load library files to the installation folder, and adding application plug-in information to the configuration file. In one embodiment, the step of unregistering further comprises deleting the application plug-in dynamic load library files from the installation folder, and deleting the application plug-in information from the configuration file. In one embodiment, the step of unregistering is performed in response to a user request.

A computer readable storage medium storing a program of instructions executable by a machine to perform one or more methods described herein also may be provided.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 illustrates the multi-level architecture of the inventive system;

FIG. 2 shows the overall flow of the inventive system;

FIG. 3 is a topological diagram of the inventive system;

FIG. 4 is a flow diagram of system start-up;

FIG. 5 is a flow diagram of registering application plug-ins in one embodiment of the inventive system;

FIG. 6 is a flow diagram of unregistering application plug-ins in one embodiment of the inventive system; and

FIG. 7 is a flow diagram of one embodiment of the inventive method.

### DETAILED DESCRIPTION

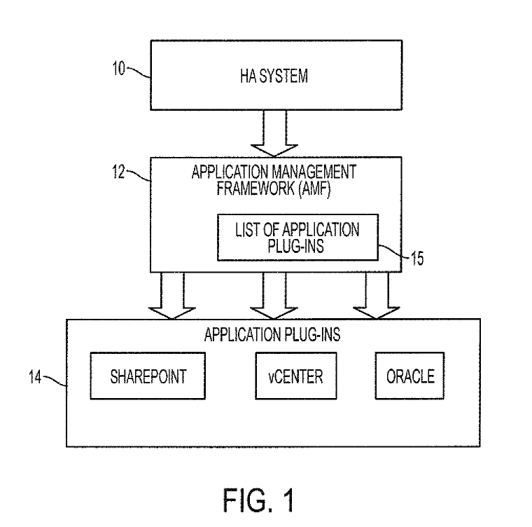

An inventive solution enabling application plug-in addition, modification and/or removal in an HA system is presented. FIG. 1 shows a multi-layer architecture of the HA system 10. The HA system 10 enables high availability of an application such as a web/internet server, a structured language query server, etc. This multi-layer architecture is easy to maintain and includes a framework or AMF 12, with a list 15 of details regarding applicable application plug-ins, and these application “plug-ins” 14. The HA system 10 includes features such as auto-discover application data for the HA application, auto-configure the standby server, validate configuration, network and/or application environment(s), start and/or stop HA, manage services for the HA application, automatic monitoring of network service including checking if the active server is alive, switchover to the standby server and/or switch back to original server, recovery, assured recovery, etc.

AMF 12 handles special application logic by managing all kinds of application plug-ins, which are named or noted in a list 15. When the HA application requests a logic not currently resident in the HA system 10, AMF 12 finds the proper application plug-in to handle the request. If there is no application plug-in available to handle the request, AMF 12 will provide default logic to handle it.

Special application logic is represented as Application Plug-ins 14, each of which is a set or collection of “Plug-in” Dynamic Link Libraries (DLLs). These Plug-ins 14 each export the same interface to handle the request from AMF 12, and provide corresponding services or logic for the AMF layer. FIG. 1 shows three Plug-ins: SharePoint, vCenter and Oracle. Any number and/or variety of plug-ins can be present in the Application Plug-ins layer 14. All Plug-ins 14 export the same interface for the framework or AMF 12. An application “Plug-in” can be easily installed into the framework, then this new application plug-in or logic can be supported by current HA system 10. The application “Plug-in” can also be easily uninstalled from the framework. The user can develop a customized application “Plug-in” based on this framework, and install the plug-in into the framework so that the HA system 10 can support the customized application plug-in as part of high availability for the HA application.

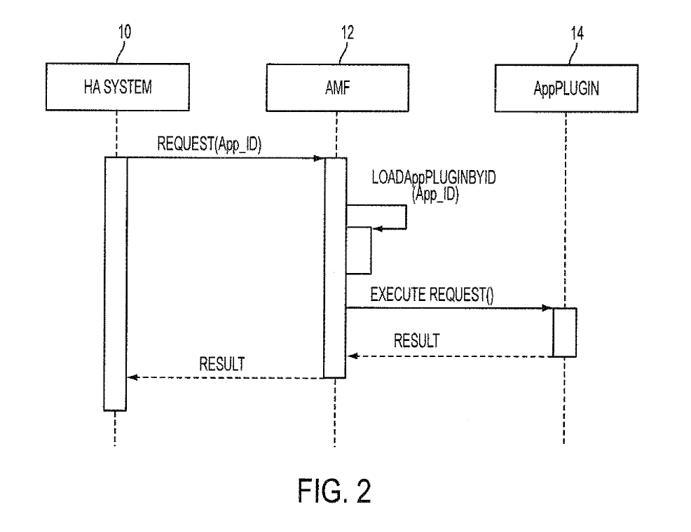

FIG. 2 shows the overall system flow of the inventive HA system 10. Initially, a user requires that a high availability application be executed. The application in the HA system 10 requires a feature or logic and sends the request for this logic to the AMF 12. The AMF 12 loads the corresponding plug-in 14 that supplies this feature or logic in support of this application. Each plug-in can be loaded using its plug-in identifier, or Plug-in-ID. Once the necessary plug-in is loaded, the request is executed and the result is returned to the application through the HA system 10.

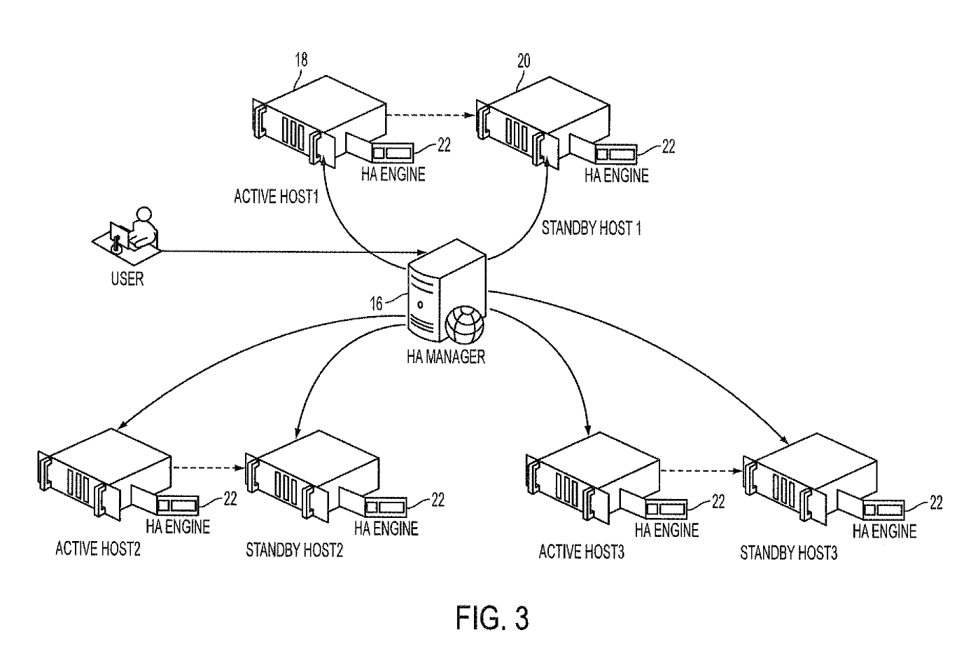

FIG. 3 is a topological diagram of the inventive system. The HA system 10 includes an HA Manager 16 that manages all of the hosts 18, 20 in the user environment. Typically a host is a physical device that includes a processor, such as a CPU, memory, disc drives, etc. The HA Manager 16 executes an HA engine 22 on the host's processor.

AMF 12 software resides in both HA Manager 16 and HA Engine 22. On HA Manager, AMF is responsible for plug-ins installation/un-installation, and for deploying plug-ins to the appropriate HA Engine. On HA Engine, AMF is responsible for handling HA requests and transferring the requests to corresponding plug-ins.

There are both active hosts 18 and standby hosts 20. Each active host 18 provides service to the user, e.g., runs a specific application, and replicates data to its corresponding standby host 20, which serves as a backup for the active host 18. Each active host 18 has an HA engine 22 which monitors application status and replicates data files of the active host 18 to the corresponding standby host 20. Each standby host 20 has an HA engine 22 which receives the application data files from the corresponding active host 18, and, when switchover occurs, the HA engine 22 of the standby host 20 manages the application services.

FIG. 3 shows an exemplary embodiment in which active host1 corresponds to, and is backed up by, standby host1, active host2 has standby host2, and active host3 has standby host3. Note that the number of active and standby hosts is not limited to three.

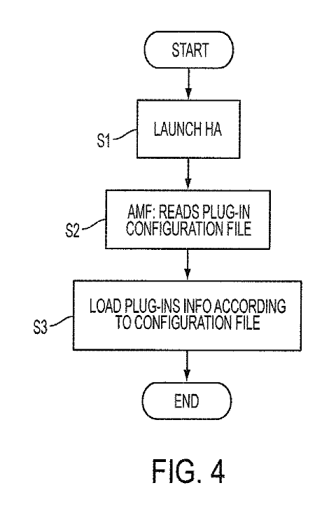

FIG. 4 is a flow diagram of the start-up of the central manager of the HA system 10. In step S1, the HA system is launched. In step S2, AMF 12 reads the plug-in configuration file. In step S3, AMF loads the plug-in information according to the configuration file.

The plug-in configuration file contains a list of application plug-in information. Each application plug-in is implemented by a set of DLLs. The application plug-in information includes at least three basic property items, as follows:

<ID> : a unique identifier or identity
<name> : name of plug-in to be shown to the users
<DLL_files> : list of and/or path for all the DLLs for the plug-in

A sample plug-in configuration follows:

```
<Plug_in_Configurations>
  <Plug_in>
  <ID>1</ID>
  <name>“SQL Server”</name>
  <DLL_files>
    <path>“[XOSoft_Plug_in_folder]\sql1.dll”</path>
    <path>“[XOSoft_Plug_in_folder]\sql2.dll”</path>
    <path>“[XOSoft_Plug_in_folder]\sql3.dll”</path>
  </DLL_files>
  </Plug_in>
  <Plug_in>
  <ID>2</ID>
  <name>“Oracle”</name>
  <DLL_files>
    <path>“[XOSoft_Plug_in_folder]\ora1.dll”</path>
    <path>“[XOSoft_Plug_in_folder]\ora2.dll”</path>
    <path>“[XOSoft_Plug_in_folder]\ora3.dll”</path>
    <path>“[XOSoft_Plug_in_folder]\ora4.dll”</path>
  </DLL_files>
  </Plug_in>
</Plug_in_Configurations>
```

An example of an application plug-in information (info) file used during installation follows. Note that this example is a “<Plugin>” node in “plug-in configuration file”.

```
<Plug_in>
  <ID>1</ID>
  <name>“SQL Server”</name>
  <DLL_files>
  <path>“c:\sql1.dll”</path>
  <path>“c:\sql2.dll”</path>
  <path>“c:\sql3.dll”</path>
  </DLL_files>
</Plug_in>
```

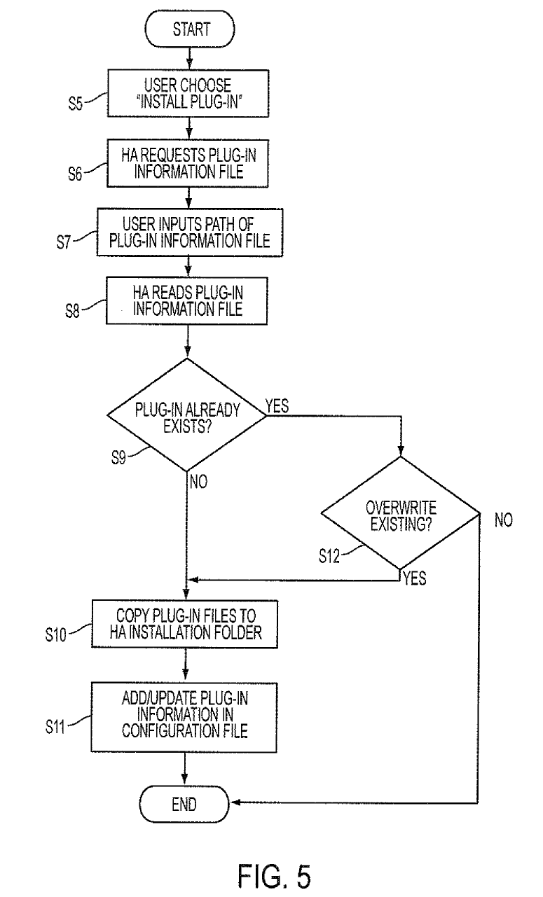

FIG. 5 is a flow diagram of a process by which a user registers application plug-ins in one embodiment of the inventive system. In step S5, a user selects “install plug-in” from the HA system manager. In step S6, the HA system manager asks the user to provide the plug-in information file. In step S7, the user inputs this information, typically in the form of a path name to the location of the plug-in information file. In step S8, the HA system manager reads the plug-in information file and, in step S9, determines if the plug-in already exists in the system. If the plug-in does not exist (S9=NO), in step S10, the plug-in files are copied into the HA system installation folder, and the HA system configuration file is updated to include the newly added plug-in in step S11.

If the plug-in does exist (S9=YES), the system determines whether or not the existing plug-in should be overwritten. If it is determined that the existing plug-in should be overwritten (S12=YES), then the process continues at step S10. In step S11, the plug-in is updated, instead of added.

Otherwise, if it is determined that the existing plug-in should not be overwritten (S12=NO), the process is complete.

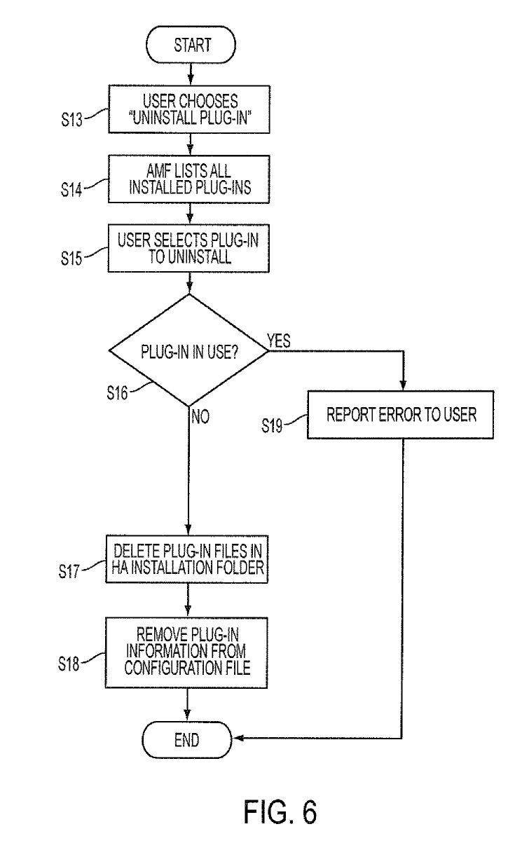

FIG. 6 is a flow diagram of a process by which a user unregisters or de-registers application plug-ins in one embodiment of the inventive system. In step S13, a user selects “uninstall plug-in” at the HA manager. In step S14, the AMF lists all installed plug-ins, enabling the user to select the plug-in to uninstall in step S15. If the plug-in is not being used (S16=NO), the plug-in files in the HA installation folder are deleted in step S17 and the plug-in information is removed from the configuration file in step S18.

Otherwise, if the plug-in is in use (S16=YES), an error is reported to the user in step S19.

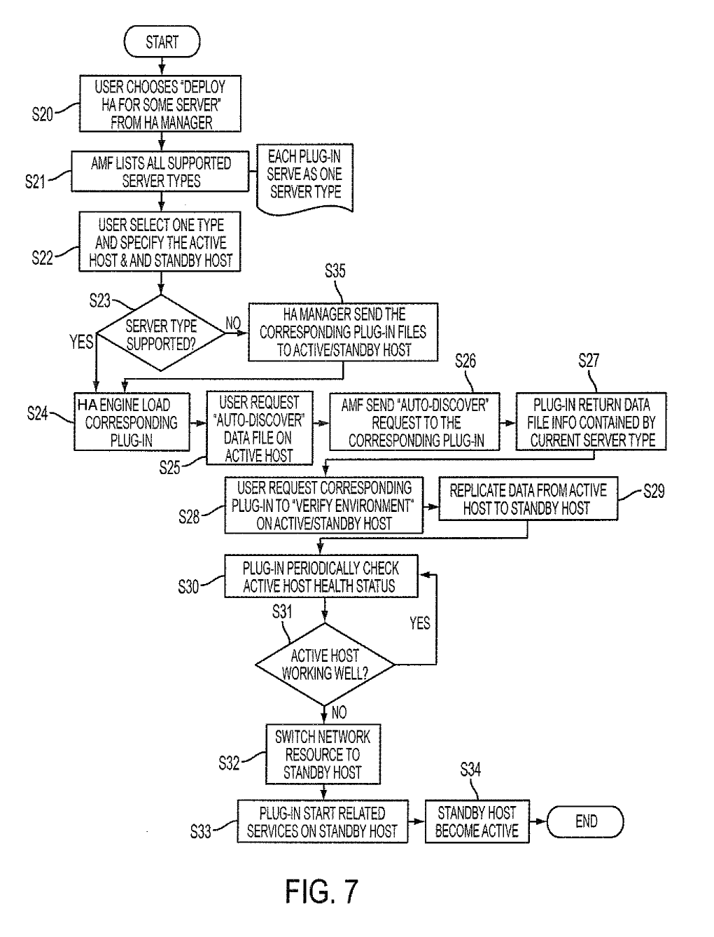

FIG. 7 is a flow diagram illustrating how the inventive process is used. In step S20, a user chooses to deploy HA for some server, e.g., “IIS”, by selecting “deploy HA” from the HA Manager 16. Such a server is a logical concept referring to a physical machine, e.g., host, running an application and/or service, for example a web server or SQL server. In step S21, AMF 12 displays a list of supported server types, that is, a list of plug-ins that exist to support IIS on the host on which HA is being deployed. Each plug-in corresponds to one application or server type. In step S22, the user selects the server type and further specifies the active and standby host. In step S23, HA Manager determines whether the selected server type is supported on the specified active host and its corresponding standby host.

If the specified hosts are supported (S23=YES), the process continues as follows. The HA engine loads the plug-ins that correspond to the selected server type or application in step S24. In step S25, auto-discover data on the active host is requested by the user. In step S26, AMF sends the “auto-discover” request to the corresponding plug-in. In step S27, the plug-in responds to the AMF request and returns the data file information required by the current server type, e.g., required by IIS. In step S28, a request to “verify environment” of the active and/or standby host is issued. In step S29, data is replicated from the active host to the standby host.

In step S30, the active host's health status is periodically checked. If the active host is healthy (S31=YES), e.g., working well according to predetermined criteria, then the health is checked again at step S30 in the next period. If the active host is not healthy (S31=N0), then the network resource is switched from active host to standby host in step S32. In step S33, the plug-in starts related services on the standby host. In step S34, the standby host becomes active.

Otherwise, if the specified hosts are not supported (S23=NO), HA Manager sends the corresponding plug-in files to the active and standby hosts in step S35. Processing then continues at step S24.

The inventive system provides numerous advantages. For example, AMF defines standard interfaces for the HA system to reuse. Defining standard interfaces for application plug-ins enables their developers to perform tasks without requiring knowledge of all of the logics in the HA system. Instead, the developers just need to know and implement the interface definition. Further, each application plug-in can be unit tested separately from other applications, and can also be maintained separately. The openness of the inventive system and framework enables the end-user to add customized application support into the original HA system. In addition, extending an application in the original HA system is simplified in comparison to existing systems.

The various functionalities and modules of the systems and methods of the present disclosure may be implemented or carried out distributedly on different processing systems or on any single platform, for instance, accessing data stored locally or distributedly on the network.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A high availability system enabling addition and removal of an application plug-in, comprising:
a central processor executing a manager;
an application framework;
an active host having a host engine executing on a host processor on the active host; and
a standby host corresponding to the active host, the standby host having a standby engine and a standby processor on the standby host, wherein the manager sends a request to the active host for data obtainable by the application plug-in, the host engine sends the request to the application framework, and when the application plug-in does not exist in the application framework, the application framework adds the application plug-in and obtains the data using the application plug-in.

2. The system according to claim 1, wherein the application framework comprises at least a list of additional application plug-ins available on the active host.

3. The system according to claim 2, wherein the list comprises a unique id, a name, and a path to dynamic load libraries for each application plug-in.

4. The system according to claim 1, wherein the manager includes at least a configuration file and an installation folder having application plug-in dynamic load library files.

5. The system according to claim 1, wherein the application framework adds the application plug-in to the application framework by adding the application plug-in dynamic load library files to the installation folder and adding application plug-in information to the configuration file.

6. The system according to claim 4, wherein the application framework removes the application plug-in from the application framework by deleting the application plug-in dynamic load library files from the installation folder and deleting the application plug-in information from the configuration file.

7. The system according to claim 1, wherein the application framework removes the application plug-in from the application framework in response to a user request.

8. A method for enabling straightforward addition and removal of an application plug-in on a high availability system, comprising steps of
launching the high availability system using a processor, said high availability system having an application framework;
requesting data obtainable by the application plug-in from the application framework; and
when the application plug-in does not exist in the application framework, registering the application plug-in in the application framework.

9. The method according to claim 8, wherein the step of registering the application plug-in comprises steps of:
loading the application framework;
reading plug-in configuration; and
loading plug-in information according to the configuration.

10. The method according to claim 8, wherein the application framework comprises at least a list of additional application plug-ins available on the active host.

11. The method according to claim 10, wherein the list comprises a unique id, a name, and a path to dynamic load libraries for each application plug-in.

12. The method according to claim 8, wherein the high availability system has a manager comprising at least a configuration file and an installation folder having application plug-in dynamic load library files.

13. The method according to claim 12, wherein the step of registering further comprises:
adding the application plug-in dynamic load library files to the installation folder; and
adding application plug-in information to the configuration file.

14. The method according to claim 12, wherein the step of unregistering further comprises:
deleting the application plug-in dynamic load library files from the installation folder; and
deleting the application plug-in information from the configuration file.

15. The method according to claim 8, wherein the step of unregistering is performed in response to a user request.

16. A computer readable storage medium storing a program of instructions executable by a machine to perform a method for enabling straightforward addition and removal of an application plug-in on a high availability system, comprising:
launching the high availability system using a processor, said high availability system having an application framework;
requesting data obtainable by the application plug-in from the application framework; and
when the application plug-in does not exist in the application framework, registering the application plug-in in the application framework.

17. The medium according to claim 8, wherein the step of registering the application plug-in comprises steps of
loading the application framework;
reading plug-in configuration; and
loading plug-in information according to the configuration.

18. The medium according to claim 16, wherein the application framework comprises at least a list of additional application plug-ins available on the active host.

19. The medium according to claim 18, wherein the list comprises a unique id, a name, and a path to dynamic load libraries for each application plug-in.

20. The medium according to claim 16, wherein the high availability system has a manager comprising at least a configuration file and an installation folder having application plug-in dynamic load library files.

21. The medium according to claim 20, wherein the step of registering further comprises:
adding the application plug-in dynamic load library files to the installation folder; and
adding application plug-in information to the configuration file.

22. The medium according to claim 20, wherein the step of unregistering further comprises:
deleting the application plug-in dynamic load library files from the installation folder; and
deleting the application plug-in information from the configuration file.

23. The medium according to claim 16, wherein the step of unregistering is performed in response to a user request.
